(19) United States
(12) Patent Application Publication
(10) Pub. No.: US 2019/0213696 A1
(43) Pub. Date: Jul. 11, 2019

(54) METHOD AND SYSTEM FOR ONLINE MARKETPLACE PLATFORM FOR ELECTRIC VEHICLE CHARGING

(71) Applicant: Omolola Elizabeth Adepoju, Sugar Land, TX (US)

(72) Inventor: Omolola Elizabeth Adepoju, Sugar Land, TX (US)

(73) Assignee: Alpha Consults LLC, Richmond, TX (US)

(21) Appl. No.: 16/354,729

(22) Filed: Mar. 15, 2019

(51) Int. Cl. G06Q 50/06; G06Q 20/18; B60L 53/66; B60L 53/68; G01S 19/51

(52) U.S. Cl. CPC G06Q 50/06; G06Q 20/18; G06Q 40/06; B60L 53/68; G01S 19/51; B60L 53/665

(57) ABSTRACT

A method and system for allowing one or more individual investors to own and operate electric vehicle charging stations including connecting to electric vehicle station manufacturers, financial institutions, electric vehicle installation companies and electric vehicle users. The integrated system comprising a computer-implemented online marketplace platform to facilitate creation of the electric charging stations by allowing interested investors incorporated with a central server using a wireless network. A plurality of servers connected to the central server via the wireless network, configured to store a plurality of data from the plurality of servers. The central server which is communicatively coupled to a plurality of user application interface. The user application interface includes an EV on-board application interface, a commercial application interface, an EV charging station application interface. The electrical on-board application interface permits a user to view one or more EV charging stations in the vicinity of the user.

### BACKGROUND OF THE INVENTION

### A. Technical Field

The present invention generally relates to an online marketplace platform for creating electric charging stations and facilitating transactions between charging stations and electric vehicles.

### B. Description of Related Art

There is a recent increase in the usage of electric vehicles. This increase in the use of electric vehicles has necessitated the need for electric charging stations. The non-availability of sufficient number of charging stations has been described as a significant limitation to the proliferation of electric vehicle usage. There are currently multiple companies and organizations that offers charging stations for the electric vehicle owners. Establishing charging stations is very capital intensive. There are also numerous electric vehicles charging stations technologies that are available in the market.

Electric vehicles contain power storage mechanisms to store electricity and power the electric vehicle. The electric storage mechanisms such as batteries in electric vehicles need to be recharged after use. Stations which recharge these batteries are rapidly being installed. Some are accessible to the public; others are not. Charging stations could be networked or non-networked and include one or more chargers configured to connect and recharge electric vehicles. Drivers of electric vehicles need to know the locations of nearby vehicle charge stations which are publicly accessible. Drivers of electric vehicles typically need access to current and reliable charging station information, including, but not limited to, location, availability and accessibility information of chargers at said charging stations.

The drawback with electric vehicles is that the range provided by batteries is limited, and the infrastructure available to users of electric vehicles is substantially reduced. The electricity used to charge the electric storage mechanisms may be provided by any type of on-vehicle power generation and charging mechanism. The on-vehicle power generation and charging mechanisms may include consumptive power generation systems and/or non-consumptive power generation systems, such as, without limitation, fuel cells, gasoline powered combustion engines, bio-diesel powered engines, solar powered generators and regenerative braking systems.

There are computer and mobile applications that are available that shows electric vehicle drivers the location of charging stations, track the charging of electric vehicle and collect charging fees. However, there is no integrated platform that allows individuals investors to own and operate electric vehicle charging stations including connecting to electric vehicle station manufacturers, financial institutions, electric vehicle installation companies and electric vehicle users.. Currently large organization requires large capital to create and own large number of electric vehicles charging stations. Thus it is difficult to replace fossil-fuel powered vehicles in this current situation.

Therefore, there is a need for a commoditized marketplace platform which could result in the proliferation of electric vehicle charging stations and aid in the spread and adoption of electric vehicles as a viable alternative to fossil fuel powered vehicles. The commoditized marketplace platform could spread the cost of creating and owning massive number of charging stations across multiple individuals. This commoditized marketplace platform will result in increasing usage of electric vehicles and increased environmental benefit of electric vehicles.

### SUMMARY OF THE INVENTION

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

The present invention is related to an integrated system for allowing one or more individual investors to own and operate electric vehicle charging stations including connecting to electric vehicle station manufacturers, financial institutions, electric vehicle installation companies and electric vehicle users. The integrated system comprising a computer-implemented online marketplace platform to facilitate creation of the electric charging stations by allowing interested investors connect with a central server using a wireless network. A plurality of servers connected to the central server via the wireless network, configured to store a plurality of data from the plurality of servers. The central server which is communicatively coupled to a plurality of user application interface. The integrated system includes a user application interface that could be connected to an EV on-board application interface, a commercial application interface, an EV charging station application interface. The electrical on-board application interface permits a user to view one or more EV charging stations in the vicinity of the user.

In one embodiment an interested individual could connect to the commercial application interface to request to own and or operate the electric charging stations based on a set of stipulated requirements in the online marketplace platform. The online marketplace platform could connect the individuals via the commercial application interface to pre-screened electric vehicle charging station manufacturers and financial institutions if financing is required, and finally coordinate the installation and maintenance of the electric charging stations.

In one embodiment the installed electric vehicle charging stations could be managed by the integrated system with the computer-implemented online marketplace platform that tracks and manage transaction during the charging of electric vehicles, including availability and utility cost. The EV charging station application interface connected to the central server could be assessed by the user and commercial applications. The user application interface allows the electric vehicle owners to sign up and view available charging stations in the marketplace and other electric vehicle charging stations. The user application interface is integrated to the computer-implemented online marketplace platform via the central server. The user application interface manages charging transactions for the user while the commercial application interface manages charging transactions and electricity usage for the owners of the electric vehicle charging stations.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIG. 1 a block diagram of a network implemented in accordance with various embodiments of the present invention is illustrated.

FIG. 2 is a flowchart illustrating a method and process of an integrated system for the creation of electric vehicle marketplace in accordance with an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

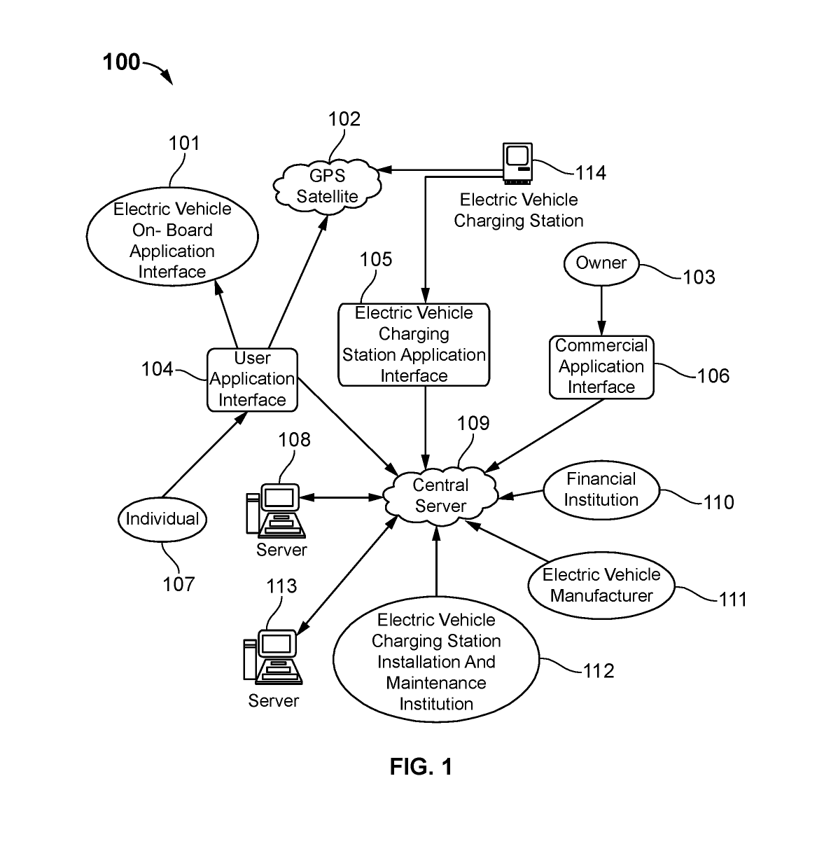

The present invention discloses a method and system for allowing one or more individual investors to own and operate electric vehicle charging stations including connecting to electric vehicle station manufacturers, financial institutions, electric vehicle installation companies and electric vehicle users. Referring to FIG. 1, a block diagram of a network 100 implemented in accordance with various embodiments of the present invention is disclosed. The network 100 comprises an EV on-board application interface 101, a GPS satellite 102, an owner 103, a user application interface 104, an EV charging station application interface 105, a commercial application interface 106, an individual 107, a plurality of servers 108, 113, a central server 109, the financial institution 110, the electric vehicle manufacturer 111, the electric vehicle charging station installation and maintenance institution 112 and the electric vehicle charging station 114. Network 100 may include connections, such as wire, wireless communication links, or fiber optic cables.

Referring to FIG. 1, is the integrated system having a computer-implemented online marketplace platform for facilitating creation of an electric vehicle charging stations 114 and transactions between the electric vehicle charging stations 114 and the electric vehicles. The computer-implemented online marketplace platform allows interested investors incorporated with the central server 109 and connected via a wireless network for facilitating creation of the electric vehicle charging station 114. The plurality of servers 108, 113 connected to the central server 109 via the wireless network configured to store a plurality of data from the plurality of servers 108, 113 in a storage unit of the central server 109. The central server 109 which is communicatively coupled to the plurality of user application interface 104. The electrical on-board application interface permits a user to view one or more EV charging stations 114 in the vicinity of the user. The user could be the owner 103 or the individual 107 for connecting their electric vehicle to the EV charging stations 114 via the user application interface 104 or commercial application interface 106.

In an embodiment the network 100 is a cloud-based system and the plurality of server 108, 113 connect to the central server 109 along with storage unit. In an embodiment, the user application interface 104 is at least one of a tablet, a mobile phone, and mobile and/or handheld electronic devices. In an embodiment, the network 100 could be Wi-Fi network, WiMax network, and wireless local area network used between the user application interface 104 and the electric vehicle charging station 114.

Referring to FIG. 1, the owner 103 could apply to own and operate an electric charging vehicle station 114 using the commercial application interface 106. The owner 103 could be an investor, a small business owner, an organization or an individual or group of individuals interested in owning and operating the electric vehicle charging station(s) 114. In an embodiment the commercial application interface 106 is a computer implemented system, method or application that is residing on a hardware such as but not limited to mobile device, tablet, laptop or any computer usable medium. In an embodiment the commercial application interface 106 is connected to the central server 109 using the wireless network but not limited to a local area network (LAN) or wide area network (WAN) or through the Internet using an Internet Service Provider. In an embodiment the commercial application interface 106 could be connected to the financial institution 110, the electric vehicle manufacturer 111, the electric vehicle installation and Maintenance Company 112. The electric vehicle charging station application interface 105 is connected to the central server 109 via the wireless network.

In one embodiment the electric vehicle charging station 114 is a hardware or a machine or a power outlet for providing electricity or charging energy to electric vehicles. The electric vehicle charging stations 114 could be a conduit of electricity to and from an electric grid. In a preferred embodiment the electric vehicle charging station 114 could be housed or hosted in a location that allow the electric vehicle to access it to obtain an electric charge. The electric vehicle charging station 114 is connected and could be controlled by an EV charging station application interface 105. The electric vehicle charging station application interface 105 is a computer implemented system or method or apparatus that is hosted on the electric vehicle charging station 114. The EV charging station application interface 105 permits the user of an electric vehicle to plug user vehicle in at any location that has an electric outlet for charging. The EV charging station application interface 105 tracks but not limited to the location of the electric vehicle charging station 114, usage and availability of the electric vehicle charging station 114, electricity utilization from the grid and electricity consumption during charging of electric vehicles and transaction fees and charges. The EV charging station application interface 105 is connected to the computer implemented online marketplace platform via the central server 109 using the local area network (LAN) but not limited to wide area network (WAN) or through the Internet using an Internet Service Provider.

In an embodiment EV charging station application interface 105 could be used to govern all aspects of an electric vehicle charging transaction. The EV charging station application interface 105 could also be used with additional infrastructure to provide electricity metering at the point of charge, identification of the various parties involved in the transaction, and flexible business rules governing the flow of funds between those parties.

In an embodiment the central server 109 serves as the hub and the wireless network connects and coordinates all the applications and systems in the computer-implemented online marketplace platform. The central server is connected to the plurality of servers 108 and 113 which serves as storage for data generated and consumed in the computer-implemented online marketplace platform. The plurality of servers 108 and 113 also host applications that could be used to optimize the online marketplace platform. In this embodiment, multiple institutions such as the financial institutions 110, the electric vehicle manufacturers 111 and the electric vehicle installations company 112 could be granted access to the online marketplace platform via user application interface 104 but not limited to API or WebPages to provided required services to the online marketplace platform.

In an embodiment the central server 109 is also connected to the user application interface 104. The user application interface 104 allows the individual 107 to view and access the electric vehicle charging stations 114 in the computer-implemented online marketplace platform. The user application interface 104 is a computer implemented method, system and apparatus that coordinate the activities of the individual 107 to use the electric vehicle charging station 114 to charge an electric vehicle and facilitates charging transactions. In one embodiment, the user application interface 104 could also allow the individual 107 to view all available charging stations in the vicinity of the individual 107. In a preferred embodiment the user application interface 104 could be connected to a GPS system 102 or mobile satellite to track the locations of the user relative to the electric charging stations 114. In an embodiment GPS system 102 connectivity allows to look for nearest charging stations, generate driving directions between individual 107 and the electric vehicle charging stations 114 and estimate wait times.

In one embodiment, the user application interface 104 could track and facilitate the charging transaction of the individual 107 including but not limited to buying charging credit, paying for charge, estimating charging wait times and duration, planning trip including single or multiple charging spots, accessing electric vehicle charging stations 114 in the network 100 and assessing the convenience of charging stations after utilization. In an embodiment the user application interface 104 could be connected to an electric vehicle on-board application interface 101 via any interface but not limited to API. The user application interface 104 is used to track actual charge usage of the electric vehicle and when charging is required.

In one embodiment the user application interface 104 allows user to pay for charging the electric vehicle. The EV charging station application interface 105 hosts a set of instructions associated with the electric charging station. The EV charging station application interface 105 controls the electric vehicle charging station 114. The electric vehicle charging station 114 is configured to charge various types of electric vehicles and hybrid electric vehicles. In an embodiment the storage unit is at least one of a volatile memory, non-volatile memory, read only memory (ROM), random access memory (RAM), a flash memory and cloud. In an embodiment the network 100 is at least one of a Local Area Network, a Wide Area Network, a Wireless Network, a telecommunication network, a mobile network, and an Internet or cloud.

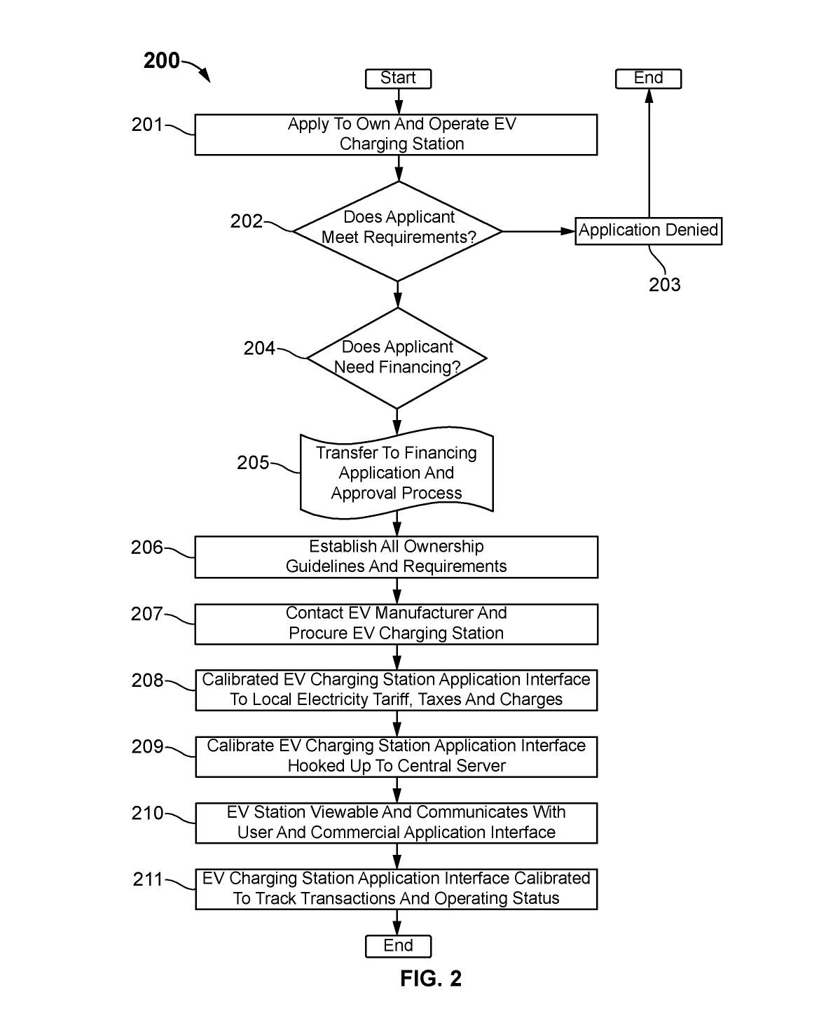

Referring to FIG. 2 is a flowchart illustrating a method and process of an integrated system for the creation of electric vehicle marketplace in accordance with an embodiment of the present invention. The method for allowing one or more individual investors to own and operate electric vehicle charging stations 114 including connecting to financial institutions 110, the electric vehicle station manufacturers 111, the electric vehicle installation companies and maintenance institution 112 and the electric vehicle users, comprising the steps of: connecting a computer-implemented online marketplace platform with the central server 109 via the wireless network to facilitate creation of the electric charging stations 114 by interested investors. Connecting a plurality of servers 108, 113 to the central server 109 via the wireless network, to store a plurality of data from the plurality of servers 108, 113 in a storage unit of the central server 109. Communicatively coupling the central server 109 to a plurality of user application interface 104, wherein the user application interface 104 including an EV on-board application interface 101, a commercial application interface 106 and an EV charging station application interface 105 permitting a user to view one or more EV charging stations 114 in the vicinity of the user.

In an embodiment the flowchart could be implemented in a computer usable program code and as a hardware and as part of the integrated system as shown in FIG. 1. The method or process 200 includes the following steps (i) A request by an investor not limited to a small business owner, an organization or an individual or group of individuals to own or operate an electric vehicle charging station, at step 201, (ii) computer-implemented online marketplace platform have a set of guidelines and requirements to ensure regulatory, safety and standard requirements to own and operate the electric vehicle charging station, at step 202. (iii) The individuals are screened based on these guidelines and their applications are either denied or forwarded to proceed with the process, at step 203, (iv)To commoditize the ownership of electric vehicle charging stations individuals could be connected to financial institutions to fund the purchase of one or more electric vehicle charging stations, at step 204, (v) processes to assess financing for the purchase and installation of the electric vehicle charging stations with options for regular installment payments based on the rules and processes of the financial institution, at step 205, (vi) Determining for the establishment of guidelines to own and operate the electric charging stations including getting required regulatory permission, site preparation, payment of all required fees and charges and signing appropriate paperwork, at step 206, (vi) The process to contact and purchase the electric vehicle charging station based on the specification imposed by the online marketplace platform, installation of the electric vehicle charging station in the location provided by the owner and the process to install the electric vehicle charging station application interface, at step 207, (vii) The electric vehicle charging station application interface tracks the usage, location, status and transaction of the electric vehicle charging station during charging of electric vehicles and the electric charging station application interface is calibrated to local electricity tariffs, taxes and charging cost to facilitate a smooth transaction during charging operation, at step 208, (Viii) the process to connect the electric vehicle application interface to the central server via a network but not limited to a local area network (LAN) or wide area network (WAN) or through the Internet using an Internet Service Provider, at step 209, (ix) the process of making the electric vehicle application viewable and integrated to all the components of the online marketplace platform including but not limited to the user and commercial applications interface and the user application interface allows owners and operators of electric vehicles to access, charge and pay for charging their electric vehicles. The commercial application interface allows owners of the electric vehicle charging stations to monitor and track the usage of their electric vehicle charging stations, at step 210. (Xi)the process of final integration of all the components of the online marketplace platform including optimization and encouraging the usage of the platform by owners 103 and individual users 107 using the EV charging station application interface which is used to track transaction and operating status, at step 211.

In one embodiment the flowchart and block diagrams in the FIG. 1 and FIG. 2 illustrate the architecture, functionality, and operation of possible implementations of systems, methods and computer program products according to various embodiments of the present invention.

In one embodiment, the user application interface 104 allows the user make payment. The payment process may authenticate the electric vehicle charging. Authentication may be achieved by implementing, for example, the use of passwords, encryption, or any other currently existing or later developed mechanism.

In one embodiment, the integrated system comprises using computing hardware, controlling an exchange of messages between plurality of servers 108, 113 to the central server 109. In one embodiment the electric vehicle charging station 114 could be a power outlet in a privately-owned garage, an electric outlet in a docking station in a commercially owned electric vehicle charging kiosk, or a power outlet in a commercially owned garage. In a preferred embodiment the user application interface 104 provides a mechanism to present information to a user after the payment is processed. The information may be presented in a visual or graphical format on a display, in an audio format, presented as a combination of audio and visual content, or in any other format.

In an embodiment the electric vehicle charging station application interface 105 is a software component and the central server 109 validates plurality of user application interface capabilities. For example, and without limitation, the electric vehicle charging station application interface 105 may include information describing the charging capabilities of the electric vehicle charging station 114, the charging requirements of the electric vehicle, the maximum storage capacity of the electric vehicle's on-vehicle storage mechanisms, the existing amount of charge in the electric vehicle, the number of amps of electricity the electric vehicle charging station 114 is capable of providing, and any other information associated with the capabilities and requirements of the electric vehicles and the electric vehicle charging station 114.

In an embodiment a secure connection could be established between the user application interface 104 and the EV on-board application interface 101 using any wired or wireless communications method, such as, without limitation, Wi-Fi, Bluetooth, telephone network, or any other network connection. The EV on-board application interface 101 could be any type of computing device, such as, without limitation, a desk top computer, a laptop computer, a personal digital assistant (PDA), or a smart phone.

In an embodiment the financial institution 110 may be a bank, a credit card company, a broker, a lender, or any other institution. For example, the financial institution 110 may be associated with owner 103 of the electric vehicle. In a preferred embodiment financial institution 110 could be associated with owners 107 of the electric vehicles and the electrical vehicle charging station 114. The financial institution 110 have preferences for controlling how amounts due are received, how charges of payments are received and accepted, how credits are issued and received, and other aspects of financial transactions associated with charging electric vehicle using the commercial application interface 106.

In an embodiment each of the parties such as investors 107 of the electric vehicles, the electric vehicle station manufacturers 111, the financial institutions 110, the electric vehicle installation companies 112 as shown in FIG. 1 may optionally have preferences, constraints, limitations, or requirements associated with charging electric vehicle. The commercial application interface 106 optionally store, manage, and retrieve some or all of these preferences, constraints, limitations, and requirements in any data storage device on the electric vehicle. The central server 109 retrieves the information of interest that is responsive to a request by the owner 103 and sends the preferences of interest to the EV on-board application interface 105 to govern the charging of electric vehicle at the electric vehicle charging station 114.

The present invention discloses the network 100 having the computer-implemented online marketplace platform for facilitating creation of electric vehicle charging stations 114 and facilitating transactions between the electric vehicle charging stations 114 and the electric vehicles. The computer-implemented online marketplace platform allows individuals 107 to apply or request to own an electric vehicle charging stations 114. The computer-implemented online marketplace platform connect user to the financial institutions 110, the charging stations manufacturer 111 and the charging station installation Company 112. The electric vehicle charging stations application interface 105 monitor the charging stations 114 including tracking location and utilization, management of charging and other fees, maintenance of charging stations and connection to electric vehicles user. The computer-implemented online marketplace platform hosts a user application interface 104 that allows individuals, including electric vehicle owners to sign up and view available electric vehicle charging station 114 locations and facilitate transactions including charging fees, wait time and location tracking. The computer-implemented online marketplace platform having the central server 109 or hub to integrate and manage all the integrated systems and application including managing incentive to apply for and use the electric vehicle charging station 114, tracking usage and facilitating transactions.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

what is claimed is:

1. An integrated system allowing one or more individual investors to own and operate electric vehicle charging stations including connecting to electric vehicle station manufacturers, financial institutions, electric vehicle installation companies and electric vehicle users, comprising:
a computer-implemented online marketplace platform to facilitate creation of the electric charging stations by allowing interested investors connect with a central server and connected via a wireless network;
a plurality of servers connected to the central server via the wireless network, configured to store a plurality of data from the plurality of servers in a storage unit of the central server;
the central server which is communicatively coupled to a plurality of user application interface, including the user application interface including an EV on-board application interface, a commercial application interface, an EV charging station application interface;
wherein the electrical on-board application interface permits a user to view one or more EV charging stations in the vicinity of the user.

2. The integrated system of claim 1, wherein the EV charging station application interface is used to track location and usage of the electric charging stations.

3. The integrated system of claim 2, wherein the EV charging station application interface is used to view the status of the electric charging stations.

4. The integrated system of claim 1, wherein the user application interface is used to view, track location and access the EV charging stations in the vicinity of the user.

5. The integrated system of claim 1, wherein the user application interface is used to pay for charging the electric vehicle.

6. The integrated system of claim 1, wherein the EV charging station application interface hosts a set of instructions associated with the electric charging station.

7. The integrated system of claim 1, wherein the EV charging station application interface controls the electric vehicle charging station.

8. The integrated system of claim 1, wherein the user application interface configured to connect with a GPS system or mobile satellite to track the location of a user relative to the electric charging stations.

9. The integrated system of claim 1, wherein the electric vehicle charging station is configured to charge various types of electric vehicles and hybrid electric vehicles.

10. The integrated system of claim 1, wherein the storage unit is at least one of a volatile memory, non-volatile memory, read only memory (ROM), random access memory (RAM), a flash memory and cloud.

11. The integrated system of claim 1, wherein the wireless network is at least one of a Local Area Network, a Wide Area Network, a Wireless Network, a telecommunication network, a mobile network, and an Internet or cloud.

12. A method for allowing one or more individual investors to own and operate electric vehicle charging stations including connecting to electric vehicle station manufacturers, financial institutions, electric vehicle installation companies and electric vehicle users, comprising the steps of:
connecting a computer-implemented online marketplace platform with a central server via a wireless network to facilitate creation of the electric charging stations by interested investors;
connecting a plurality of servers to the central server via the wireless network, to store a plurality of data from the plurality of servers in a storage unit of the central server;
communicatively coupling the central server to a plurality of user application interface, wherein the user application interface including an EV on-board application interface, a commercial application interface and an EV charging station application interface;
permitting a user to view one or more EV charging stations in the vicinity of the user using the electrical on-board application interface.

13. The method of claim 12, wherein the electric vehicle charging station charges various types of electric vehicles and hybrid electric vehicles.

14. The method of claim 12, wherein the commercial application interface approves, finance, installs and request maintenance of various electric vehicle charging stations.

15. The method of claim 12, wherein the user application interface views, tracks location and access the EV charging stations in the vicinity of the user.

16. The method of claim 12, wherein the user using the user application interface pay for charging the electric vehicle.

17. The method of claim 12, wherein the EV charging station application interface hosts a set of instructions associated with the electric charging station.

18. The method of claim 12, wherein the EV charging station application interface controls the electric vehicle charging station.

19. The method of claim 12, wherein the storage unit is at least one of a volatile memory, non-volatile memory, read only memory (ROM), random access memory (RAM), a flash memory and cloud.

20. The method system of 12, wherein the wireless network is at least one of a Local Area Network, a Wide Area Network, a Wireless Network, a telecommunication network, a mobile network, and an Internet or cloud.
